(19) United States
(12) Patent Application Publication
(10) Pub. No.: US 2024/0348301 A1
(43) Pub. Date: Oct. 17, 2024

(54) CONTROL APPARATUS, CONTROL METHOD, AND RECORDING MEDIUM

(71) Applicant: NEC Corporation, Tokyo (JP)

(72) Inventors: Jun SHIKIDA, Tokyo (JP); Kazushi Muraoka, Tokyo (JP)

(73) Assignee: NEC Corporation, Tokyo (JP)

(21) Appl. No.: 18/631,174

(22) Filed: Apr. 10, 2024

(30) Foreign Application Priority Data
Apr. 12, 2023 (JP) 2023-064960

(51) Int. Cl. H04B 7/06; H04W 52/24

(52) U.S. Cl. CPC H04B 7/0619; H04W 52/245

(57) ABSTRACT

A control apparatus controls communication between a wireless terminal and a wireless apparatus. The control apparatus includes: a calculation unit that calculates a channel gain between the wireless terminal and the wireless apparatus when a beam is used, by using a reference signal transmitted by the wireless terminal using the beam; an estimation unit that estimates reception quality when the wireless terminal performs reception by using the beam, based on the channel gain and transmission power of the wireless apparatus; and an allocation unit that allocates at least one of a radio resource and a modulation and coding scheme to the wireless terminal, based on the reception quality.

### INCORPORATION BY REFERENCE

This application is based upon and claims the benefit of priority from Japanese Patent Application No. 2023-064960, filed on Apr. 12, 2023, the disclosure of which is incorporated herein in its entirety by reference.

### TECHNICAL FIELD

Example embodiments of this disclosure relate to technical fields of a control apparatus, a control method, and a recording medium in a mobile communication system.

### BACKGROUND ART

In order to realize high-speed, large-capacity wireless communication, utilization of a high-frequency band is advancing where a wide bandwidth can be secured. For example, a millimeter-wave band is supported in the fifth-generation mobile communication system (5G). In addition, in the sixth-generation mobile communication system (6G), support is considered in a terahertz-wave band that is higher in frequency than the millimeter-wave band.

In the wireless communication of the high-frequency band, a large propagation loss is one of the problems. In the high-frequency band, the wireless terminal is assumed to be equipped with a plurality of antenna panels in in order to compensate for the propagation loss. Each antenna panel forms a beam in a different direction, by which a radio wave can be transmitted and received in any direction.

A base station in the mobile communication system allocates a radio resource and modulation and coding scheme, to a wireless terminal in view of a channel state of the wireless terminal. In a case where the wireless terminal is equipped with a plurality of antenna panels and performs beam forming, the base station, the base station needs to grasp the channel state that takes into account an effect/influence of the beam and the antenna panels used by the wireless terminal.

Patent Literature 1 describes a method of reporting channel state information from the wireless terminal to the base station when the wireless terminal is equipped with a plurality of antenna panels. As an example of the channel state information, CQI (Channel Quality Indicator) or L1-SINR (Layer 1 Signal to Interference plus Noise Ratio) is described.

As other background art documents related to this disclosure, Patent Literature 2 to Patent Literature 4 are cited.

### BACKGROUND ART DOCUMENTS

### Patent Literature

Patent Literature 1: International Publication No. WO2022/201551
Patent Literature 2: JP2022-547093A
Patent Literature 3: International Publication No. WO2021/220482
Patent Literature 4: International Publication No. WO2021/192173

### SUMMARY

The channel state information reported to the base station by the method described in Patent Literature 1, however, represents the channel state at the time of past measurement, and does not necessarily match the channel state at the time of communication. For example, when the wireless terminal moves or a surrounding environment of the wireless terminal changes, the channel state may be significantly different between at the time of measurement and at the time of communication of the channel state information. In a case where the channel state is different between at the time of measurement and at the time of communication, the base station may not be capable of properly allocating the radio resource and the modulation and coding scheme to the wireless terminal, and communication speed may decrease.

It is an example object of this disclosure to solve the above-described problems, and to provide a control apparatus, a control method, a computer program, and a recording medium that are capable of properly allocating at least one of the radio resource and the modulation and coding scheme in accordance with a communication state, in a case where the wireless terminal performs beamforming.

A control apparatus according to an example aspect of this disclosure is,
a control apparatus that controls communication between a wireless terminal and a wireless apparatus, the control apparatus including:
a calculation unit that calculates a channel gain between the wireless terminal and the wireless apparatus when a first beam is used, by using a reference signal transmitted by the wireless terminal using the first beam;
an estimation unit that estimates reception quality when the wireless terminal performs reception by using the first beam, based on the channel gain and transmission power of the wireless apparatus; and
an allocation unit that allocates at least one of a radio resource and a modulation and coding scheme to the wireless terminal, based on the reception quality.

A control method according to an example aspect of this disclosure is,
a control method that controls communication between a wireless terminal and a wireless apparatus, the control method including:
calculating a channel gain between the wireless terminal and the wireless apparatus when a first beam is used, by using a reference signal transmitted by the wireless terminal using the first beam;
estimating reception quality when the wireless terminal performs reception by using the first beam, based on the channel gain and transmission power of the wireless apparatus; and
allocating at least one of a radio resource and a modulation and coding scheme to the wireless terminal, based on the reception quality.

A recording medium according to an example aspect of this disclosure is,
a non-transitory recording medium that records thereon a computer program that allows a computer including a processor and a memory, to execute a control method that controls communication between a wireless terminal and a wireless apparatus,
the control method including:
calculating a channel gain between the wireless terminal and the wireless apparatus when a first beam is used, by using a reference signal transmitted by the wireless terminal using the first beam;
estimating reception quality when the wireless terminal performs reception by using the first beam, based on the channel gain and transmission power of the wireless apparatus; and
allocating at least one of a radio resource and a modulation and coding scheme to the wireless terminal, based on the reception quality.

### Effect

According to the example aspects of this disclosure, it is possible to properly allocate, to the wireless terminal, at least one of the radio resource and the modulation and coding scheme in accordance with the communication state, in the case where the wireless terminal performs beamforming.

### BRIEF DESCRIPTION OF THE DRAWINGS

FIG. 1 is a block diagram illustrating a configuration of a control apparatus in a first example embodiment;

FIG. 2 is a flowchart illustrating a flow of operation of the control apparatus in the first example embodiment;

FIG. 3 is a block diagram illustrating a configuration of a wireless communication system in a second example embodiment;

FIG. 4 is a block diagram illustrating a configuration of a control apparatus in the second example embodiment;

FIG. 5 is a block diagram illustrating a configuration of a scheduling unit in the second example embodiment;

FIG. 6 is a flowchart illustrating a flow of operation of the control apparatus in the second example embodiment; and

FIG. 7 is diagram illustrating a combination of software and hardware that realizes a function of the control apparatus in the first example embodiment.

### EXAMPLE EMBODIMENTS

Hereinafter, example embodiments of this disclosure will be described with reference to the drawings.

### First Example Embodiment

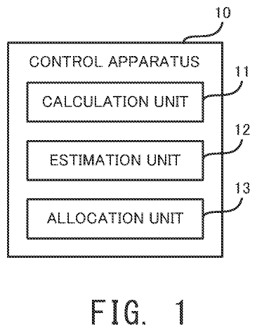

FIG. 1 is a block diagram illustrating a configuration of a control apparatus 10 in a first example embodiment. The control apparatus 10 is an apparatus that is connected to a wireless apparatus and that controls communication between a wireless terminal and the wireless apparatus. The control apparatus 10 may be connected to a plurality of wireless apparatuses, and may control communication between the wireless terminal and the plurality of wireless apparatuses. As illustrated in FIG. 1, the control apparatus 10 includes a calculation unit 11, an estimation unit 12, and an allocation unit 13.

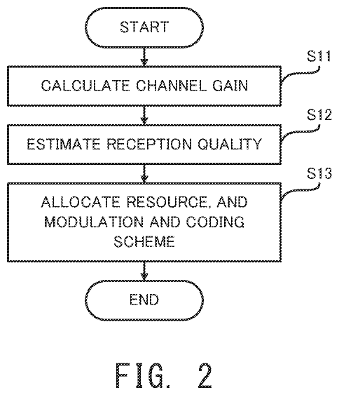

FIG. 2 is a flowchart illustrating a flow of operation of the control apparatus in the first example embodiment.

The calculation unit 11 calculates a channel gain between the wireless terminal and the wireless apparatus (step S11). When the control apparatus 10 is connected to a plurality of wireless apparatuses, the calculation unit 11 may calculate each channel gains between the wireless terminal and each of the plurality of wireless apparatuses. Specifically, the calculation unit 11 calculates the channel gain when the wireless terminal uses a beam, by using a reference signal transmitted by the wireless terminal using the beam. The beam formed by the wireless terminal may be referred to as a first beam. The wireless terminal in the first example embodiment performs transmission and reception by using the first beam.

The estimation unit 12 estimates reception quality of the wireless terminal (step S12). The estimation unit 12 estimates the reception quality when the wireless terminal performs reception by using the beam. Specifically, the estimation unit 12 estimates the reception quality of the wireless terminal, based on the channel gain calculated by the calculation unit 11 and transmission power of the wireless apparatus.

The allocation unit 13 allocates at least one of a radio resource and modulation and coding scheme to the wireless terminal (step S13). Specifically, the allocation unit 13 allocates at least one of the radio resource and the modulation and coding scheme, based on the reception quality of the wireless terminal estimated by the estimation unit 12.

As described above, the control apparatus 10 in the first example embodiment calculates the channel gain between the wireless terminal and the wireless apparatus when the wireless terminal uses the beam, estimates the reception quality of the wireless terminal based on the calculated channel gain and the transmission power of the wireless apparatus, and allocates at least one of the radio resource and the modulation and coding scheme to the wireless terminal based on the estimated reception quality. For this reason, the control apparatus 10 is allowed to estimate the reception quality of the wireless terminal in accordance with a communication state, in a case where the wireless terminals perform beamforming. Therefore, the control apparatus 10 is capable of properly allocating, to the wireless terminal, at least one of the radio resource and the modulation and coding scheme in accordance with the communication state, in the case where the wireless terminal performs beamforming.

### Second Example Embodiment

Next, a second example embodiment will be described. The second example embodiment is a specific example of the first example embodiment.

### <Configuration of Wireless Communication System>

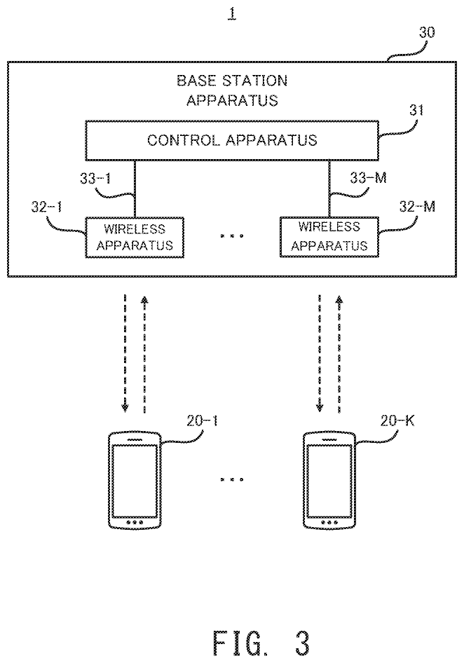

FIG. 3 is a block diagram illustrating a configuration of a wireless communication system 1 in the second example embodiment. The wireless communication system 1 is, for example, a system conforming to the technical specifications of 3GPP (Third Generation Partnership Project). The wireless communication system 1 may be a system conforming to the technical specifications of 5G, or may be a system conforming to the technical specifications of 4G, or may be a system conforming to the technical specifications of 3G. Of course, the wireless communication system 1 is not limited to these examples, and may be a system conforming to technical specifications that are different from the technical specifications of 3GPP.

As illustrated in FIG. 3, the wireless communication system 1 includes a plurality of wireless terminals 20-1 to 20-K and a base station apparatus 30, where K is an integer of 2 or more. In the following, when it is not necessary to distinguish the wireless terminals 20-1 to 20-K, each of them may be simply referred to as a “wireless terminal 20”.

The wireless terminal 20 may be referred to as a User Equipment (UE), or a mobile station, or the like. The wireless terminal 20 may be a mobile terminal such as a smartphone, a mobile phone, and a tablet, for example. The wireless terminal 20 may be a relay apparatus having a relay function.

The base station apparatus 30 is an apparatus that is configured to perform wireless communication with the wireless terminal 20. The base station apparatus 30 may be, for example, a node of a RAN (Radio Access Network). The base station apparatus 30 may be a BTS (Base Transceiver Station), a NodeB, an eNodeB (evolved NodeB), or a gNodeB (next generation NodeB).

In the following description, a link through which a signal is transmitted from the base station apparatus 30 to the wireless terminal 20 is referred to as a “downlink.” The signal transmitted on the downlink is referred to as a “downlink signal.” Additionally, a link through which a signal is transmitted from the wireless terminal 20 to the base station apparatus 30 is referred to as an “uplink”. The signal transmitted on the uplink is referred to as an “uplink signal.”

As illustrated in FIG. 3, the base station apparatus 30 includes a control apparatus 31 and a plurality of wireless apparatuses 32-1 to 32-M. The control apparatus 31 is connected to each of the wireless apparatuses 32-1 to 32-M through respective one of transmission paths 33-1 to 33-M, where M is an integer of 2 or more. In the following, when it is not necessary to distinguish the wireless apparatuses 32-1 to 32-M, each of them may be simply referred to as a “wireless apparatus 32.” Furthermore, when it is not necessary to distinguish the transmission paths 33-1 to 33-M, each of them may be simply referred to as a “transmission path 33.”

The control apparatus 31 is an apparatus that is configured to control communication between the wireless terminal 20 and the base station apparatus 30. The control apparatus 31 may be, for example, a CU (Central Unit or Centralized Unit), or may be a DU (Distributed Unit). The control apparatus 21 may include a partial function of a RU (Radio Unit or Remote Unit), for example.

The wireless apparatus 32 is an apparatus that is configured to perform wireless communication with the wireless terminal 20 under the control of the control apparatus 31. The wireless apparatus 32 may be, for example, a RU (Radio Unit or a Remote Unit), a TRP (Transmission and Reception point), or an Access Point (AP). The wireless apparatus 32 may include only a partial function of the RU. The wireless apparatus 32 may be disposed at a position that is physically away from the control apparatus 31.

The transmission path 33 is a medium used for information transmission. The transmission path 33 may be, for example, an optical fiber, a metal cable, or a wireless propagation path. In communication in the transmission path 33, a RoF (Radio over Fiber) technology may be applied, or a CPRI (Common Public Radio Interface) technology may be applied, or an eCPRI (evolved Common Public Radio Interface) technology or the like may be applied.

### <Configuration of Control Apparatus>

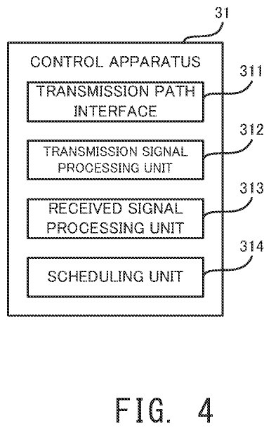

FIG. 4 is a block diagram illustrating a configuration of the control apparatus 31 in the second example embodiment. The control apparatus 31 includes a transmission path interface 311, a transmission signal processing unit 312, a received signal processing unit 313, and a scheduling unit 314.

The transmission path interface 311 is an interface for communicating with the wireless apparatus 32 through the transmission path 33.

The transmission signal processing unit 312 performs a transmission process on a downlink signal that is to be transmitted from the base station apparatus 30 to the wireless terminal 20. The transmission signal processing unit 312 generates a downlink signal to be transmitted to the wireless terminal 20. The transmission signal processing unit 312 transmits the downlink signal to the wireless apparatus 32 through the transmission path interface 311 and the transmission path 33.

The received signal processing unit 313 performs a reception process on an uplink signal that is received by the base station apparatus 30 from the wireless terminal 20. The received signal processing unit 313 receives the uplink signal received by the wireless apparatus 32, through the transmission path interface 311 and the transmission path 33. The received signal processing unit 313 performs a demodulation process and a decoding process on the uplink signal.

The received signal processing unit 313 receives a reference signal in the uplink transmitted by the wireless terminal 20. The received signal processing unit 313 may transmit a signal in which the received reference signal in the uplink is included, to the scheduling unit 314. Alternatively, the received signal processing unit 313 may estimate frequency response or impulse response of a channel in the uplink, by using the signal in which the received reference signal in the uplink is included, and may transmit an estimated value of the frequency response or impulse response of the channel, to the scheduling unit 314.

The scheduling unit 314 allocates at least one of the radio resource and the modulation and coding scheme (MCS), which are used for communication with the wireless terminal 20. The radio resource may include at least one of an antenna, a beam, transmission power, time and frequency, and the like. The scheduling unit 314 transmits a result of allocation of at least one of the radio resource and the modulation and coding scheme, to the transmission signal processing unit 312 and the received signal processing unit 313. The scheduling unit 314 may transmit the result of allocation of at least one of the radio resource and the modulation and coding scheme, to the wireless apparatus 32 through the transmission path interface 311 and the transmission path 33.

### <Configuration of Scheduling Unit>

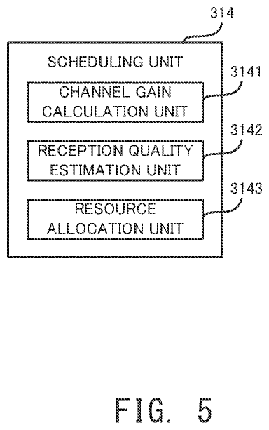

FIG. 5 is a block diagram illustrating a configuration of the scheduling unit 314 according to the second example embodiment. The scheduling unit 314 includes a channel gain calculation unit 3141, a reception quality estimation unit 3142, and a resource allocation unit 3143.

The channel gain calculation unit 3141 calculates a channel gain between the wireless terminal 20 and the wireless apparatus 32. The channel gain calculation unit 3141 may calculate the channel gain between the wireless terminal 20 and the wireless apparatus 32, by using the signal in which the reference signal in the uplink received from the received signal processing unit 313 is included. Alternatively, the channel gain calculation unit 3141 may calculate the channel gain between the wireless terminal 20 and the wireless apparatus 32, by using the estimated value of the frequency response or impulse response of the channel received from the received signal processing unit 313. The channel gain calculation unit 3141 transmits the calculated channel gain between the wireless terminal 20 and the wireless apparatus 32 to the reception quality estimation unit 3142.

The reception quality estimation unit 3142 estimates reception quality of the wireless terminal 20, by using the channel gain between the wireless terminal 20 and the wireless apparatus 32 received from the channel gain calculation unit 3141 and information about transmission power of the wireless apparatus 32 received from the resource allocation unit 3143. The reception quality estimation unit 3142 transmits the estimated reception quality of the wireless terminal 20 to the resource allocation unit 3143.

The resource allocation unit 3143 allocates at least one of the radio resource and the modulation and coding scheme to the wireless terminal 20 based on a result of estimation of the reception quality of the wireless terminal 20 received from the reception quality estimation unit 3142. If necessary, the resource allocation unit 3143 transmits, to the reception quality estimation unit 3142, the result of allocation of the radio resource to the wireless terminal 20. The resource allocation unit 3143 transmits, to the transmission signal processing unit 312 and the received signal processing unit 313, the result of allocation of at least one of the radio resource and the modulation and coding scheme to the wireless terminal 20. The resource allocation unit 3143 may transmit the result of allocation of at least one of the radio resource and the modulation and coding scheme to the wireless terminal 20, to the wireless apparatus 32 through the transmission path interface 311 and the transmission path 33.

### <Operation of Control Apparatus>

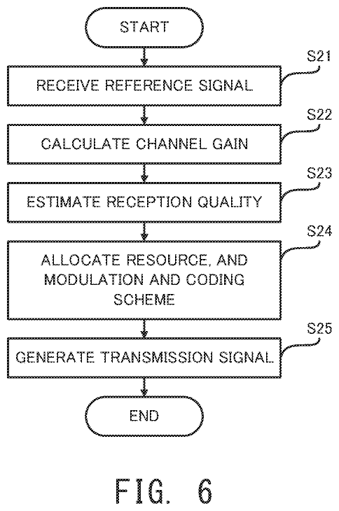

FIG. 6 is a flowchart illustrating a flow of operation of the control apparatus 31 in the second example embodiment. With reference to FIG. 6, the operation of the control apparatus 31 will be described.

The received signal processing unit 313 receives the signal in which the reference signal in the uplink transmitted by the wireless terminal 20 is included, from the wireless apparatus 32 through the transmission path interface 311 and the transmission path 33 (step S21). The received signal processing unit 313 may transmit the received signal in which the reference signal in the uplink is included, to the scheduling unit 314. Alternatively, the received signal processing unit 313 may estimate the frequency response or impulse response of the channel in the uplink, from the received signal in which the reference signal in the uplink is included, and may transmit the estimated value of the frequency response or impulse response of the channel, to the scheduling unit 314.

The wireless terminal 20 may perform beamforming when transmitting the reference signal in the uplink. The control apparatus 31 may instruct the wireless terminal 20 to set the beam to be used by the wireless terminal 20 for transmission. In this instance, the received signal processing unit 313 is allowed to distinguish the beam used by the wireless terminal 20 from the others, and to process the received signal.

As an example of the operation of the received signal processing unit 313, a case where the received signal processing unit 313 estimates the frequency response of the channel, will be described below. In the following, N_{SC} represents the number of subcarriers, and B represents the number of beams that can be used by the wireless terminal 20. s_{n,k,b} represents the reference signal in the uplink in a subcarrier n (where n is an integer that is greater than or equal to 1 and less than or equal to N_{SC}), which is transmitted by a wireless terminal 20-k (where k is an integer that is greater than or equal to 1 and less than or equal to K) by using a beam b (where b is an integer that is greater than or equal to 1 and less than or equal to B). y_{n,k,b,m} represents the signal in the subcarrier n in which the reference signal in the uplink transmitted from the wireless terminal 20-k by using the beam b is included, wherein the signal in the subcarrier n is received by the wireless apparatus 32-m (where m is an integer that is greater than or equal to 1 and less than or equal to M). In this case, frequency response h_{n,k,b,m} of the channel in the subcarrier n between the wireless terminal 20-k and the wireless apparatus 32-m when the beam b is used, can be expressed as in Equation (1).

$${h}_{n , k , b , m} = \frac{{y}_{n , k , b , m}}{{s}_{n , k , b}} \qquad [ Equation ( 1 ) ]$$

The received signal processing unit 313 transmits the estimated frequency response of the channel, to the scheduling unit 314. However, the number of frequency responses of the channel to be transmitted to the scheduling unit 314 may be limited. That is, the received signal processing unit 313 may omit the transmission to the scheduling unit 314, of any of the frequency response h_{n,k,b,m} of the channel in each combination of the wireless terminal 20-k, the beam b, the subcarrier n, and the wireless apparatus 32-m. Alternatively, the received signal processing unit 313 may transmit, to the scheduling unit 314, only any of the frequency response h_{n,k,b,m} of the channel in each combination of the wireless terminal 20-k, the beam b, the subcarrier n, and the wireless apparatus 32-m. For example, the number of frequency responses of the channel to be transmitted to the scheduling unit 314 may be limited based on RSRP (Reference Signal Received Power) in the downlink transmitted by the wireless apparatus 32, wherein RSRP is reported from the wireless terminal 20. Alternatively, the number of frequency responses of the channel to be transmitted to the scheduling unit 314 may be limited based on an instruction from the channel gain calculation unit 3141.

The channel gain calculation unit 3141 calculates the channel gain between the wireless terminal 20 and the wireless apparatus 32 (step S22). The channel gain calculation unit 3141 may calculate the channel gain between the wireless terminal 20 and the wireless apparatus 32, by using the signal in which the reference signal in the uplink received from the received signal processing unit 313 is included. Alternatively, the channel gain calculation unit 3141 may calculate the channel gain between the wireless terminal 20 and the wireless apparatus 32, by using the estimated value of the frequency response or impulse response of the channel received from the received signal processing unit 313.

As an example of a method of calculating the channel gain in the channel gain calculation unit 3141, a case of using the frequency response of the channel received from the received signal processing unit 313, will be described below. A channel gain g_{k,b,m} between the wireless terminal 20-k and the wireless apparatus 32-m when the beam b is used, is calculated as in Equation (2), by using the frequency response h_{n,k,b,m} of the channel in the subcarrier n between the wireless terminal 20-k and the wireless apparatus 32-m when the beam b is used, wherein the frequency response h_{n,k,b,m} is received from the received signal processing unit 313.

$${g}_{k , b , m} = \frac{1}{{N}_{SC}} {\sum }_{n = 1}^{{N}_{SC}} {\vert {h}_{n , k , b , m} \vert}^{2} \qquad [ Equation ( 2 ) ]$$

Equation (2) represents, but this disclosure is not limited to, a case where one channel gain is calculated by using N_{SC} subcarriers. For example, N_{SC} subcarriers may be used to calculate a plurality of channel gains. In this instance, the channel gain calculation unit 3141 may use a smaller number of subcarriers than N_{SC} to calculate one channel gain.

The reception quality estimation unit 3142 estimates the reception quality of the wireless terminal 20, by using the channel gain between the wireless terminal 20 and the wireless apparatus 32 received from the channel gain calculation unit 3141 and the information about the transmission power of the wireless apparatus 32 received from the resource allocation unit 3143 (step S23).

An example of a method of estimating the reception quality of the wireless terminal 20 in the reception quality estimation unit 3142 will be described below. The reception quality of the wireless terminals 20 depends on a transmission method of the wireless apparatus 32. In the following, the wireless apparatus 32-m is assumed to transmit the downlink signal to the wireless terminal 20-k. In this instance, the downlink signal transmitted from a wireless apparatus other than the wireless apparatus 32-m is regarded as an interference signal for the wireless terminal 20-k. The reception quality estimation unit 3142 estimates SINR as reception quality γ. In the following, Pm represents the transmission power of the wireless apparatus 32-m, and 02 represents an estimated value of noise power in the wireless terminal 20-k. In this instance, reception quality γ_{k,bk} of the wireless terminal 20-k at the time of reception using the beam bₖ (where bₖ is an integer that is greater than or equal to 1 and less than or equal to B) can be expressed as in Equation (3).

$${A}_{k} = {\sum }_{{k}^{′} = 1}^{k} {w}_{{k}^{′}} f ( {γ}_{{k}^{′} , {b}_{{k}^{′}}} ) \qquad [ Equation ( 4 ) ]$$

The first term of a denominator in Equation (3) represents the interference signal for the wireless terminal 20-k transmitted from the wireless apparatus other than the wireless apparatus 32-m. When a wireless apparatus 32-m′ does not transmit the downlink signal, however, transmission power Pm′ of the wireless apparatus 32-m′ is assumed to be set to 0. The second term of the denominator in Equation (3) represents the estimated value of the noise power, σ². The estimated value of the noise power, σ², may be set while thermal noise is assumed, for example. Alternatively, in consideration of the presence of interference from other than the wireless apparatus 32, a value that is greater than the thermal noise may be set as σ². In other words, a numerator in Equation (3) may represent the power of a desired signal of the received signal. To put it differently, the denominator in Equation (3) may represent the power of a signal other than the desired signal of the received signal.

The resource allocation unit 3143 allocates at least one of the radio resource and the modulation and coding scheme to the wireless terminal 20, based on the result of estimation of the reception quality of the wireless terminal 20 received from the reception quality estimation unit 3142 (step S24).

An example of a method of allocating the radio resource in the resource allocation unit 3143 will be described below. In the following, a process of allocating the radio resource to the wireless terminal 20-k is assumed to be performed in a situation where the radio resource is already allocated to the wireless terminal 20-1 to the wireless terminal 20-(k−1). The resource allocation unit 3143 determines the allocation of the radio resource based on metrics, for example. A metric Aₖ when the radio resource is allocated to the wireless terminals 20-1 to 20-K can be expressed as in Equation (4).

$${γ}_{k , {b}_{k}} = \frac{{g}_{k , {b}_{k} , m} {P}_{m}}{{\sum }_{\begin{matrix}{m}^{′} = 1 \\ {m}^{′} \neq m\end{matrix}}^{M} {g}_{k , {b}_{k} , {m}^{′}} {P}_{{m}^{′}} + {σ}^{2}} \qquad [ Equation ( 3 ) ]$$

where w_{k′} represents a weighting factor for the wireless terminal 20-k′, and b_{k′} represents the beam used by the wireless terminal 20-k′ to receive the downlink signal. As the weighting factor w_{k′}, for example, an inverse of mean throughput of the wireless terminal 20-k′ may be used. Furthermore, f(γ) is a function for converting an input SINRγ to a transmission rate. The conversion to the transmission rate may be conversion to Shannon capacity, or conversion to amount of mutual information, or conversion to frequency utilization efficiency defined based on the modulation and coding scheme. The resource allocation unit 3143 may compare the metric Aₖ when the radio resource is allocated to the wireless terminals 20-1 to 20-K with a metric Aₖ₋₁ when the radio resource is allocated to the wireless terminals 20-1 to 20-(k−1), and may allocate the radio resource to the wireless terminal 20-k when Aₖ is larger than Aₖ₋₁. Since SINR of the wireless terminals 20-1 to 20-(k−1) may depend on whether or not the radio resource is allocated to the wireless terminal 20-k, the reception quality estimation unit 3142 may estimate SINR of the wireless terminals 20-1 to 20-K in the calculation of the metric Aₖ. Alternatively, the resource allocation unit 3143 may have a function of estimating the SINR of the wireless terminals 20-1 to 20-K.

The resource allocation unit 3143 may set the transmission power of the wireless apparatus 32 to be a fixed value, or may set it based on an allocation state of the radio resource. The resource allocation unit 3143 may set the transmission power of each wireless apparatus 32 so as to maximize the metrics of Equation (4), for example. Since the reception quality of the wireless terminal 20 depends on the transmission power of the wireless apparatus 32, the reception quality estimation unit 3142 or the resource allocation unit 3143 may estimate the reception quality of the wireless terminal 20 when the transmission power of the wireless apparatus 32 is changed.

An example of a method of allocating the modulation and coding scheme in the resource allocation unit 3143 will be described below. After the end of the allocation of the radio resource to the wireless terminals 20-1 to 20-K, the resource allocation unit 3143 allocates the modulation and coding scheme to each wireless terminal 20 to which the radio resource is allocated. The resource allocation unit 3143 allocates the modulation and coding scheme based on the reception quality SINR of the wireless terminal 20. For example, the resource allocation unit 3143 may set a target value of SINR for each modulation and coding scheme in advance, and may allocate the modulation and coding scheme that maximizes the frequency utilization efficiency under the condition that SINR exceeds the target value.

The transmission signal processing unit 312 generates the downlink signal based on the result of allocation of at least one of the radio resource and the modulation and coding scheme to the wireless terminal 20 received from the resource allocation unit 3143 (step S25). The transmission signal processing unit 312 transmits the generated downlink signal to the wireless apparatus 32 through the transmission path interface 311 and the transmission path 33.

### <Effect>

As described above, in the wireless communication system 1 according to the second example embodiment, the control apparatus 31 calculates the channel gain between the wireless terminal 20 and each of the plurality of wireless apparatuses 32 when the wireless terminal 20 uses the beam, estimates the reception quality of the wireless terminal 20 based on the calculated channel gain and the information about the transmission power of the wireless apparatus 32, and allocates at least one of the radio resource and the modulation and coding scheme to the wireless terminal 20 based on the estimated reception quality. For this reason, the control apparatus 31 is allowed to estimate the reception quality of the wireless terminal 20 in consideration of the beam used by the wireless terminal 20 and the transmission power of the wireless apparatus 32. Therefore, the control apparatus 31 is capable of properly allocating, to the wireless terminal 20, at least one of the radio resource and the modulation and coding scheme in accordance with the communication state, in the case where the wireless terminal 20 performs beamforming.

### MODIFIED EXAMPLES

The techniques/technologies according to this disclosure are not limited to the example embodiments described above. Two or more example aspects that are arbitrarily selected from the above example embodiments and the following modified examples, may be combined as appropriate, as long as they do not conflict with each other.

### (1) First Modified Example

A second example of the method of calculating the channel gain in the channel gain calculation unit 3141 will be described below. In the second example, the reference signal received power RSRP in the downlink reported from the wireless terminal 20 is used, in addition to the estimated value of the frequency response or impulse response of the channel.

R_{k,b,m} represents RSRP for the wireless apparatus 32-m when the wireless terminal 20-k performs reception by using the beam b. In addition, Pₘ^{DL-RS} represents the transmission power of a reference signal in the downlink transmitted by the wireless apparatus 32-m. At this time, the channel gain g_{k,b,m} between the wireless terminal 20-k and the wireless apparatus 32-m when the beam b is used, can be expressed as in Equation (5).

$${g}_{k , b , m} = \frac{{R}_{k , b , m}}{{P}_{m}^{DL - RS}} \qquad [ Equation ( 5 ) ]$$

For the wireless apparatus other than the wireless apparatus 32-m, the channel gain calculation unit 3141 calculates the channel gain by using the channel gain determined by Equation (5) and the estimated value of the frequency response or impulse response of the channel. The channel gain g_{k,b,m′} between the wireless terminal 20-k and the wireless apparatus 32-m′ (where m′ is an integer that is greater than or equal to 1 and less than or equal to M, but excluding m) when the beam b is used, can be expressed as in Equation (6).

$${g}_{k , b , {m}^{′}} = {g}_{k , b , m} \cdot \frac{{\sum }_{n = 1}^{{N}_{SC}} {\vert {h}_{n , k , b , {m}^{′}} \vert}^{2}}{{\sum }_{n = 1}^{{N}_{SC}} {\vert {h}_{n , k , b , m} \vert}^{2}} \qquad [ Equation ( 6 ) ]$$

Equation (6) represents a case where one channel gain is calculated by using N_{SC} subcarriers, but this disclosure is not limited thereto. For example, N_{SC} subcarriers may be used to calculate a plurality of channel gains. In this instance, the channel gain calculation unit 3141 may use a smaller number of subcarriers than N_{SC} to calculate one channel gain.

As described above, in the second example of the method of calculating the channel gain in the channel gain calculation unit 3141, the reference signal received power RSRP in the downlink reported from the wireless terminal 20 is used, in addition to the estimated value of the frequency response or impulse response of the channel. As can be seen from Equation (5) and Equation (6), in the second example, the channel gain calculation unit 3141 calculates the channel gain for the wireless apparatus 32-m, which could be a standard, based on RSRP, and uses the estimated value of the frequency response or impulse response of the channel to calculate a channel gain ratio between the wireless apparatus 32-m and another wireless apparatus. That is, in the second example, the channel gain calculation unit 3141 uses the estimated value of the frequency response or impulse response of the channel, as a relative value of the channel gain among the plurality of wireless apparatuses 32. Therefore, by using the second example, it is possible to calculate the channel gain, accurately, even in a case where an absolute value of the estimated value of the frequency response or impulse response of the channel is not accurate due to implementation issues of the base station apparatus 30.

### (2) Second Modified Example

The channel gain calculation unit 3141 may limit the number of the wireless apparatuses 32 that calculate the channel gain, in accordance with the wireless terminal 20 that is a channel gain calculation target. The channel gain calculation unit 3141 may calculate the channel gain between the wireless terminal 20 and each of any wireless apparatuses 32 out of the plurality of wireless apparatuses 32. The channel gain calculation unit 3141 may calculate the channel gain between the wireless terminal 20 and each of the wireless apparatuses 32 that satisfy a predetermined condition out of the plurality of wireless apparatuses 32. For example, the channel gain calculation unit 3141 may determine the wireless apparatus 32 that calculates the channel gain, based on RSRP. Specifically, the channel gain calculation unit 3141 may set the wireless apparatus 32 in which RSRP is large, as the channel gain calculation target. Alternatively, the channel gain calculation unit 3141 may omit the calculation of the channel gain for the wireless apparatus 32 in which the channel gain is low in the past, based on a past result of calculation of the channel gain.

In a case where the channel gain calculation unit 3141 omits the calculation of the channel gain for the wireless apparatus 32 in which the channel gain is expected to be small, there is a possibility of reducing a processing load of the control apparatus 31 while preventing degradation of accuracy of estimation of the reception quality of the wireless terminal 20.

### (3) Third Modified Example

The reception quality estimation unit 3142 may estimate interference noise power including the interference from other than the wireless apparatus 32, in order to estimate the reception quality of the wireless terminal 20. The reception quality estimation unit 3142 may use at least one of CQI, SINR, and RSRQ (Reference Signal Reception quality) reported from the wireless terminal 20, in order to estimate the interference noise power including the interference from other than the wireless apparatus 32. An example of a method of estimating the interference noise power including the interference from other than the wireless apparatus 32, will be described below.

A description will be given to an example of an estimation method in which the reception quality estimation unit 3142 estimates the interference noise power including the interference from other than the wireless apparatus 32 by using RSRQ reported from the wireless terminal 20. RSRQ is an index representing the reception quality of the wireless terminal 20 in a mobile communication system conforming to 3GPP. In the wireless terminal 20, RSRP and RSSI (Received Signal Strength Indicator) have a predetermined relation to RSRP and RSRQ. Therefore, the reception quality estimation unit 3142 is allowed to calculate RSSI from RSRP and RSRQ reported from the wireless terminal 20. Furthermore, RSSI is a value obtained by adding all the received powers of a desired signal, an interference signal, and a noise signal. Thus, the reception quality estimation unit 3142 is capable of estimating the interference noise power including the interference from other than the wireless apparatus 32, by deriving RSSI from RSRQ and RSRP and excluding the received power of the signal corresponding to the wireless apparatus 32 from the derived RSSI. The RSSI derived from RSRQ is a value measured in the past. Therefore, when excluding the received power of the signal corresponding to the wireless apparatus 32 from RSSI, the reception quality estimation unit 3142 may use at least one of the channel gain and the transmission power of the wireless apparatus 32 in the measurement of RSRQ.

A description will be given to an example of an estimation method in which the reception quality estimation unit 3142 estimates the interference noise power including the interference from other than the wireless apparatus 32 by using SINR reported from the wireless terminal 20. The received power of a desired signal that is a numerator of SINR, can be obtained from RSRP. Therefore, the reception quality estimation unit 3142 is capable of deriving a denominator of SINR from SINR and RSRP. The denominator of SINR is a sum of the noise power and the received power of an interference signal. The reception quality estimation unit 3142 is capable of estimating the interference noise power including the interference from other than the wireless apparatus 32, by excluding the received power of the interference signal corresponding to the wireless apparatus 32 from the denominator of SINR. When excluding the received power of the interference signal corresponding to the wireless apparatus 32 from the denominator of SINR, the reception quality estimation unit 3142 may use at least one of the channel gain and the transmission power of the wireless apparatus 32 in the measurement of SINR.

A description will be given to an example of an estimation method in which the reception quality estimation unit 3142 estimates the interference noise power including the interference from other than the wireless apparatus 32 by using CQI reported from the wireless terminal 20. CQI is generally converted from SINR. Therefore, the reception quality estimation unit 3142 is allowed to obtain SINR from CQI by inverse conversion. The reception quality estimation unit 3142 may estimate the interference noise power including the interference from other than the wireless apparatus 32, from the obtained SINR, in the same manner as the above-described methods. For example, a conversion table including a correlation between CQI and SINR may be prepared in advance. The reception quality estimation unit 3142 may perform inverse conversion from CQI to SINR, by using the conversion table.

As described above, the reception quality estimation unit 3142 estimates the interference noise power including the interference from other than the wireless apparatus 32. Therefore, it is possible to accurately grasp the interference noise power including the interference from other than the wireless apparatus 32, and it is possible to accurately estimate the reception quality of the wireless terminal 20.

### (4) Fourth Modified Example

The reception quality estimation unit 3142 may estimate the reception quality based on information about at least one of the antenna panel and the beam used when the wireless terminal 20 performs reception. The reception quality estimation unit 3142 may acquire, from the wireless terminal 20, information about a method of using at least one of the antenna panel and the beam when the downlink signal is received in the wireless terminal 20. In a case where the reception quality estimation unit 3142 uses the information about the method of using at least one of the antenna panel and the beam in the wireless terminal 20, it is possible to improve the accuracy of estimation of the reception quality of the wireless terminal 20. For example, in a case where the wireless terminal 20 includes a plurality of antenna panels and the number of the antenna panels to be used is adaptively changed in accordance with the communication state, it is possible to improve the accuracy of estimation of the reception quality of the wireless terminal 20, by obtaining the information about the method of using the antenna panel from the wireless terminal 20.

### (5) Fifth Modified Example

Although the above description does not refer to the beam used by the wireless apparatus 32, this disclosure can be readily extended to a case where the wireless apparatus 32 uses a plurality of beams. An example of the operation of the control apparatus 31 when the wireless apparatus 32 uses a plurality of beams, will be described below. The beam formed by the wireless apparatus 32 may be referred to as a second beam. In a fifth modified example, the wireless apparatus 32 and the wireless terminal 20 may communicate by using the second beam, instead of or in addition to the first beam.

The received signal processing unit 313 or the channel gain calculation unit 3141 may estimate the frequency response or impulse response of the channel, for each of the beams of the wireless apparatus 32.

The channel gain calculation unit 3141 may calculate the channel gain, for each of the beams of the wireless apparatus 32.

The reception quality estimation unit 3142 may estimate the reception quality of the wireless terminal 20 by using the channel gain corresponding to the beam allocated by the resource allocation unit 3143. The channel gain corresponding to the beam allocated by the resource allocation unit 3143, however, may not be calculated by the channel gain calculation unit 3141. For example, the channel gain corresponding to the interference signal may not be calculated for all the beams used by the wireless apparatus 32. For the channel gain that is not calculated in the channel gain calculation unit 3141, the channel gain of another beam whose beam direction is close, may be used, or an average value of the channel gains of other beams may be used.

The resource allocation unit 3143 may allocate beam used by the wireless apparatus 32 to the wireless terminal 20, based on RSRP, for example. In a case where the wireless apparatus 32 transmits the reference signal in the downlink while changing the beam and the beam in which RSRP is large is reported from the wireless terminal 20 to the control apparatus 31, the resource allocation unit 3143 is allowed to allocate an appropriate beam to the wireless terminal 20.

### (6) Sixth Modified Example

Although the above description exemplifies a case where the wireless apparatus 32 includes one transceiver unit (TXRU), this disclosure can be easily extended to a case where the wireless apparatus 32 includes a plurality of TXRUs. An example of the operation of the control apparatus 31 when the wireless apparatus 32 uses a plurality of TXRUs will be described below. TXRU may be referred to as a RF (Radio Frequency) chain.

The received signal processing unit 313 may estimate the frequency response of the channel for each TXRU. Alternatively, in a case where the channel gain can be considered to be equal among the plurality of TXRUs, the received signal processing unit 313 may estimate the frequency response of the channel only for one TXRU.

The channel gain calculation unit 3141 may calculate the channel gain for each TXRU. Alternatively, in a case where the channel gain can be considered to be equal among the plurality of TXRUs, the channel gain calculation unit 3141 may calculate the channel gain for only one TXRU.

The reception quality estimation unit 3142 may estimate the reception quality of the wireless terminal 20 by using the channel gain corresponding to TXRU allocated by the resource allocation unit 3143. In a case where interference from a TXRU other than the TXRU allocated to the wireless terminal 20 is expected, the reception quality of the wireless terminal 20 may be estimated in consideration of the interference from the other TXRU. For example, in a case where a plurality of TXRUs correspond to different polarized waves, the interference from the other TXRU may be considered not to occur, or a small level of interference may be considered to occur.

The resource allocation unit 3143 may allocate TXRU to the wireless terminal 20 based on RSRP, for example. Alternatively, in a case where the reception quality is considered to be equal among the plurality of TXRUs, the resource allocation unit 3143 may randomly allocate any of the plurality of TXRUs to the wireless terminal 20.

### Another Example Embodiment

The above-described example embodiments and modified examples are merely exemplary, and the scope of technical ideas/concepts of this disclosure is not limited to the above-described configurations. Other example aspects considered within the scope of technical ideas/concepts of this disclosure are also included within the scope of this disclosure.

The processing steps of the control method illustrated in the flowcharts may not necessarily be performed in the illustrated order. The processing steps may be performed in the order that is different from the illustrated one, and two or more processing steps may be performed in parallel. In addition, a part of the processing steps may be removed, and an additional processing step may be added.

The function of each of the apparatus described above (e.g., the control apparatus 10, the base station apparatus 30, the control apparatus 31, and the wireless apparatus 32) may be realized or implemented by any of software, hardware, and a combination of software and hardware. A program code (an instruction) that constitutes the software may be stored in a computer-readable recording medium disposed inside or outside each apparatus, for example. The program code may be read into a memory in execution thereof and may be executed by the processor. Furthermore, a computer-readable non-transitory recording medium on which the program code is recoded, may also be provided.

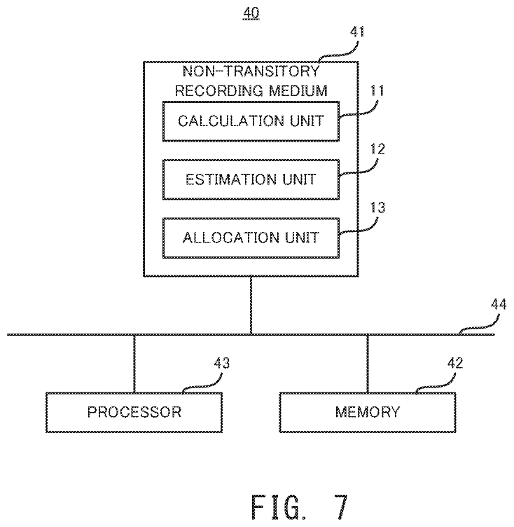

For example, FIG. 7 is diagram illustrating a combination of software and hardware that realizes the functions of the control apparatus 10 described in the first example embodiment. An information processing apparatus 40 includes a non-transitory recording medium 41, a memory 42, and a processor 43. The non-transitory recording medium 41, the memory 42, and the processor 43 are connected to each other through an internal bus 44. The non-transitory recording medium 41 records thereon a program code that realizes or implements functional blocks of the control apparatus 10 (specifically, the calculation unit 11, the estimation unit 12, and the allocation unit 13). The program code for realizing or implementing the functional blocks of the control apparatus 10 is read into the memory 42. The processor 43 executes the program code read into the memory 42, thereby perform the processes of the functional blocks of the control apparatus 10. In the same manner, each of the base station apparatus 30, the control apparatus 31, and the wireless apparatus 32 may be realized or implemented by a combination of a non-transitory recording medium, a memory, and a processor.

### (Supplementary Notes)

With respect to the example embodiments described above, the following Supplementary Notes are further disclosed.

### [Supplementary Note 1]

A control apparatus that controls communication between a wireless terminal and a wireless apparatus, the control apparatus comprising:
a calculation unit that calculates a channel gain between the wireless terminal and the wireless apparatus when a first beam is used, by using a reference signal transmitted by the wireless terminal using the first beam;
an estimation unit that estimates reception quality when the wireless terminal performs reception by using the first beam, based on the channel gain and transmission power of the wireless apparatus; and
an allocation unit that allocates at least one of a radio resource and a modulation and coding scheme to the wireless terminal, based on the reception quality.

### [Supplementary Note 2]

The control apparatus according to Supplementary Note 1, wherein the calculation unit calculates the channel gain, by using received power of a reference signal transmitted by the wireless apparatus when the wireless terminal performs reception by using the first beam.

### [Supplementary Note 3]

The control apparatus according to Supplementary Note 1 or 2, wherein
the control apparatus controls communication between the wireless terminal and a plurality of wireless apparatuses, and
the calculation unit calculates a channel gain between the wireless terminal and each of any wireless apparatuses out of the plurality of wireless apparatuses.

### [Supplementary Note 4]

The control apparatus according to any one of Supplementary Notes 1 to 3, wherein the estimation unit estimates received power of a signal received by the wireless terminal from other than the wireless apparatus, and estimates the reception quality by using the received power.

### [Supplementary Note 5]

The control apparatus according to any one of Supplementary Notes 1 to 5, wherein the estimation unit estimates the reception quality based on information about at least one of an antenna panel and a beam used when the wireless terminal performs reception.

### [Supplementary Note 6]

The control apparatus according to any one of Supplementary Notes 1 to 5, wherein
the calculation unit calculates the channel gain when the wireless apparatus uses a second beam, and
the estimation unit estimates the reception quality by using the channel gain when the wireless apparatus uses the second beam.

### [Supplementary Note 7]

The control apparatus according to any one of Supplementary Notes 1 to 6, wherein the estimation unit estimates the reception quality corresponding to a transceiver unit used by the wireless apparatus to communicate with the wireless terminal.

### [Supplementary Note 8]

A control method that controls communication between a wireless terminal and a wireless apparatus, the control method comprising:
calculating a channel gain between the wireless terminal and the wireless apparatus when a first beam is used, by using a reference signal transmitted by the wireless terminal using the first beam;
estimating reception quality when the wireless terminal performs reception by using the first beam, based on the channel gain and transmission power of the wireless apparatus; and
allocating at least one of a radio resource and a modulation and coding scheme to the wireless terminal, based on the reception quality.

### [Supplementary Note 9]

A non-transitory recording medium that records thereon a computer program that allows a computer including a processor and a memory, to execute a control method that controls communication between a wireless terminal and a wireless apparatus,
the control method including:
calculating a channel gain between the wireless terminal and the wireless apparatus when a first beam is used, by using a reference signal transmitted by the wireless terminal using the first beam;
estimating reception quality when the wireless terminal performs reception by using the first beam, based on the channel gain and transmission power of the wireless apparatus; and
allocating at least one of a radio resource and a modulation and coding scheme to the wireless terminal, based on the reception quality.

### [Supplementary Note 10]

A computer program that allows a computer including a processor and a memory, to execute a control method that controls communication between a wireless terminal and a wireless apparatus,
the control method including:
calculating a channel gain between the wireless terminal and the wireless apparatus when a first beam is used, by using a reference signal transmitted by the wireless terminal using the first beam;
estimating reception quality when the wireless terminal performs reception by using the first beam, based on the channel gain and transmission power of the wireless apparatus; and
allocating at least one of a radio resource and a modulation and coding scheme to the wireless terminal, based on the reception quality.

### DESCRIPTION OF REFERENCE NUMERALS

1 Wireless communication system
10, 31 Control apparatus
11 Calculation unit
12 Estimation unit
13 Allocation unit
20 Communication terminal
30 Base station apparatus
32 Wireless apparatus
33 Transmission path
311 Transmission path interface
312 Transmission signal processing unit
313 Received signal processing unit
314 Scheduling unit
3141 Channel gain calculation unit
3142 Reception quality estimation unit
3143 Resource allocation unit
40 Information processing apparatus
41 Non-transitory recording medium
42 Memory
43 Processor
44 Internal bus

What is claimed is:

1. A control method that controls communication between a wireless terminal and a wireless apparatus, the control method comprising:
obtaining a channel gain between the wireless terminal and the wireless apparatus when a first beam is used, by using a reference signal transmitted by the wireless terminal using the first beam;
estimating reception quality when the wireless terminal performs reception by using the first beam, based on the channel gain and transmission power of the wireless apparatus; and
allocating at least one of a radio resource and a modulation and coding scheme to the wireless terminal, based on the reception quality.

2. The control method according to claim 1, wherein
the channel gain is obtained, by using received power of a reference signal transmitted by the wireless apparatus when the wireless terminal performs reception by using the first beam.

3. The control method according to claim 1, wherein
communication is controlled between the wireless terminal and a plurality of wireless apparatuses, and
a channel gain is obtained between the wireless terminal and each of any wireless apparatuses out of the plurality of wireless apparatuses.

4. The control method according to claim 1, wherein received power of a signal received by the wireless terminal from other than the wireless apparatus is estimated, and the reception quality is estimated by using the received power.

5. The control method according to claim 1, wherein the reception quality is estimated based on information about at least one of an antenna panel and a beam used when the wireless terminal performs reception.

6. The control method according to claim 1, wherein
the channel gain is calculated when the wireless apparatus uses a second beam, and
the reception quality is estimated by using the channel gain when the wireless apparatus uses the second beam.

7. The control method according to claim 1, wherein the reception quality corresponding to a transceiver unit used by the wireless apparatus to communicate with the wireless terminal is estimated.

8. A control apparatus that controls communication between a wireless terminal and a wireless apparatus, the control apparatus comprising:
at least one memory that is configured to store instructions; and
at least one first processor that is configured to execute the instructions to:
obtain a channel gain between the wireless terminal and the wireless apparatus when a first beam is used, by using a reference signal transmitted by the wireless terminal using the first beam;
an estimation unit that estimates reception quality when the wireless terminal performs reception by using the first beam, based on the channel gain and transmission power of the wireless apparatus; and
an allocation unit that allocates at least one of a radio resource and a modulation and coding scheme to the wireless terminal, based on the reception quality.

9. A non-transitory recording medium that records thereon a computer program that allows a computer including a processor and a memory, to execute a control method that controls communication between a wireless terminal and a wireless apparatus,
the control method including:
obtaining a channel gain between the wireless terminal and the wireless apparatus when a first beam is used, by using a reference signal transmitted by the wireless terminal using the first beam;
estimating reception quality when the wireless terminal performs reception by using the first beam, based on the channel gain and transmission power of the wireless apparatus; and
allocating at least one of a radio resource and a modulation and coding scheme to the wireless terminal, based on the reception quality.
